(19) United States
(12) Patent Application Publication
(10) Pub. No.: US 2025/0182192 A1
(43) Pub. Date: Jun. 5, 2025

(54) SYSTEMS AND METHODS FOR VEHICLE RECOMMENDATIONS

(71) Applicant: Toyota Motor Credit Corporation, Plano, TX (US)

(72) Inventors: Michael Reid, Prosper, TX (US); Joshua Batie, Frisco, TX (US)

(73) Assignee: Toyota Motor Credit Corporation, Plano, TX (US)

(21) Appl. No.: 18/526,865

(22) Filed: Dec. 1, 2023

(51) Int. Cl. G06Q 30/0645; G07C 5/02; G07C 5/08

(52) U.S. Cl. CPC G06Q 30/0645; G07C 5/02; G07C 5/08

(57) ABSTRACT

A system includes a vehicle having a plurality of sensors, an onboard electronic control unit communicatively coupled to the plurality of sensors, and a server device communicatively coupled to the electronic control unit. One or more processors are configured to generate vehicle operation data, generate vehicle environment data, generate a plurality of leasing options based on the one or more driving behaviors or vehicle conditions, the plurality of environment conditions, and a current market data for a specified vehicle. When the user has a current lease, the processor determines a plurality of changed lease terms corresponding to the analyzed driving behavior, the plurality of vehicle conditions, and the current market data. When the user does not have a current lease, the processor determines a plurality of new lease terms based on the analyzed driving behavior, the plurality of vehicle conditions, and the current market data for the specified vehicle.

### TECHNICAL FIELD

The present disclosure generally relates to lease recommendations, as well as methods for making recommendations.

### TECHNICAL BACKGROUND

With a lease of a vehicle, the vehicle may be obtained for an amount lower than the entire value of the vehicle. This allows for the use of typically more expensive vehicles. A lease is for a predetermined time with certain immutable parameters such as a fixed number of miles and months.

Drivers may attempt to estimate their driving habits to avoid extra charges, however they may not be aware of their driving habits or their driving habits may change over time. For example, drivers can also choose the duration of a lease but may underestimate or overestimate how long the lease will be desired. When certain parameters are exceeded additional charges may apply.

### SUMMARY

An embodiment of the present disclosure takes the of form of a system including a vehicle, a plurality of sensors communicatively coupled to the vehicle, an onboard electronic control unit communicatively coupled to the plurality of sensors, and a server device communicatively coupled to the electronic control unit. The server device includes a memory component, a database and one or more processors. The one or more processors are configured to generate vehicle operation data characterizing one or more driving behaviors or vehicle conditions detected during operation of the vehicle, generate vehicle environment data characterizing a plurality of environment conditions surrounding the vehicle during operation of the vehicle, generate a plurality of leasing options based on the one or more driving behaviors or vehicle conditions, the plurality of environment conditions, and a current market data for a specified vehicle, and determine whether the user has a current lease, wherein when the user has a current lease, the processor determines a plurality of changed lease terms and propose a change in the lease terms to fit a need of the user based on the analyzed driving behavior, the plurality of vehicle conditions, and the current market data for the specified vehicle, and wherein when the user does not have a current lease, the processors determines a plurality of new lease terms based on the analyzed driving behavior, the plurality of vehicle conditions, and the current market data for the specified vehicle.

Another embodiment of the present disclosure takes the of form of a method including generating vehicle operation data characterizing one or more driving behaviors or vehicle conditions detected during operation of the vehicle, generating vehicle environment data characterizing a plurality of environment conditions surrounding the vehicle during operation of the vehicle, generating a plurality of leasing options based on the analyzed driving behavior or vehicle conditions, the plurality of environment conditions, and a current market data for a specified vehicle, and determining whether the user has a current lease. When the user has a current lease, the method includes determining a plurality of changed lease terms and proposing a change in the lease terms to better fit a need of the user based on the analyzed driving behavior, the vehicle conditions, the plurality of environment conditions, and the current market data for the specified vehicle. When the user does not have a current lease, the method includes determining a plurality of new lease terms based on the analyzed driving behavior, the plurality of vehicle conditions, and the current market data for the specified vehicle.

A further embodiment of the present disclosure takes the form of a method including generating vehicle operation data characterizing one or more driving behaviors or vehicle conditions detected during operation of the vehicle, generating vehicle environment data characterizing a plurality of environment conditions surrounding the vehicle during operation of the vehicle, generating a driving score based on the driving behavior, vehicle conditions, and plurality of environment conditions, generating a plurality of leasing options based on the driving score and a current market data for a specified vehicle, and determining whether the user has a current lease. When the user has a current lease, the method includes determining a plurality of changed lease terms and proposing a change in the lease terms to better fit a need of the user based on the driving score and the current market data for the specified vehicle. When the user does not have a current lease, the method includes determining a plurality of new lease terms based on the driving score and the current market data for the specified vehicle.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts components of an example electronic control unit of the example vehicle and components according to one or more embodiments described and illustrated herein;

FIG. 2 depicts an example of the data storage device of FIG. 1 according to one or more embodiments shown and described herein;

FIG. 3 depicts a flow diagram, according to one or more embodiments shown and described herein; and

FIG. 4 depicts a diagram various computing environments, according to one or more embodiments shown and described herein.

### DETAILED DESCRIPTION

The present disclosure provides for utilizing vehicle usage information and market information to provide a user with options to change the typically immutable parameters of a lease so that the lease may better conform to their usage of the vehicle. An advantage to conforming a lease for a vehicle based the user's actual usage behavior may provide a more economical and enjoyable lease experience for a user. Embodiments herein include a database and a memory with logic modules for utilizing vehicle and market data to improve the vehicle leasing experience for users. These and additional embodiments and benefits will be described in greater detail below.

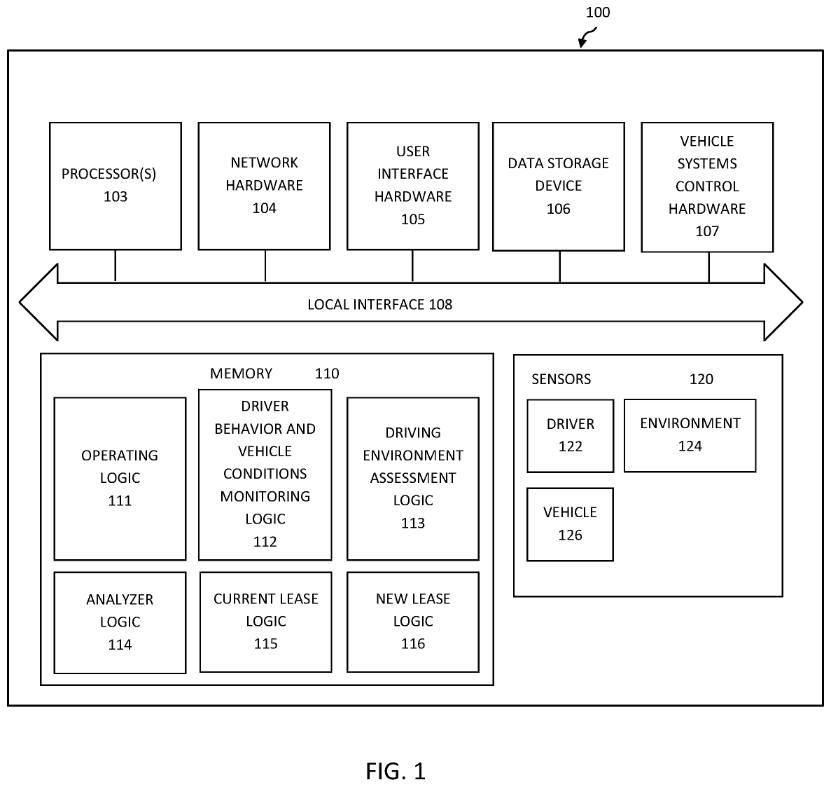

Referring to FIG. 1, electronic control unit 100 may generally be a computing system positioned within a vehicle. In some embodiments, the electronic control unit 100 may be a plurality of computing systems. As also illustrated in FIG. 1, the electronic control unit 100 may include a processor 103, network hardware 104, data storage device 106, vehicle systems control hardware, memory component 110, and sensors 120. A local interface 108, such as a bus or the like, may interconnect the various components.

The local interface 108 may include any wired or wireless networking hardware, such as a modem, a LAN port, a wireless fidelity (Wi-Fi) card, WiMax card, mobile communications hardware, and/or other hardware for communicating with other networks and/or devices. For example, the local interface 108 may provide a communications link between the electronic control unit 100, processor 103, network hardware 104, user interface hardware 105, data storage device 106, vehicle systems control hardware 107, vehicle systems control hardware, memory 110, sensors 120, and the other components of a network, user computing devices, server computing devices, and the like. That is, in embodiments, the local interface 108 is configured to receive signals and transform the signals into a data signal indicative of the recommendation from the electronic control unit 100.

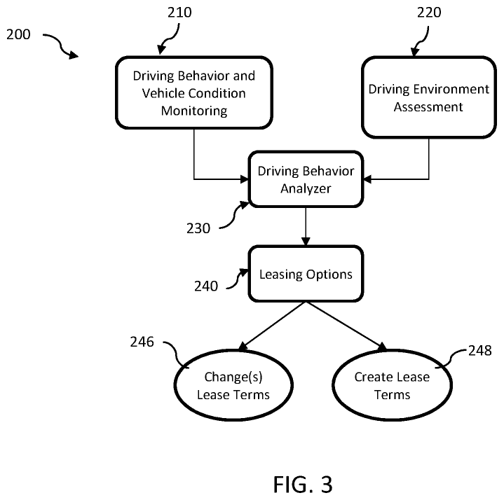

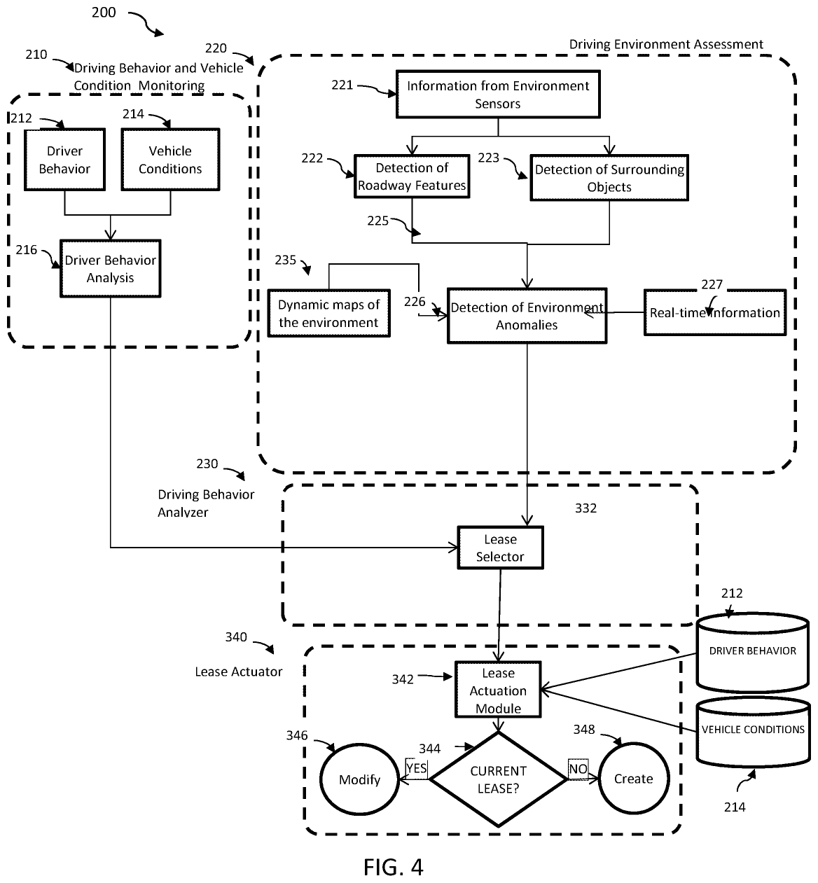

The memory component 110 may be configured as a volatile and/or a nonvolatile computer-readable medium and, as such, may include random access memory (including SRAM, DRAM, and/or other types of random access memory), read only memory (ROM), flash memory, registers, compact discs (CD), digital versatile discs (DVD), and/or other types of storage components. The memory component 110 may include one or more programming instructions thereon that, when executed by the processor 103, cause the processor 103 to complete various processes, such as the processes described herein with respect to FIGS. 3-4. The programming instructions stored on the memory component 110 may be embodied as a plurality of software logic modules, such as operating logic 111, driver behavior and vehicle conditions monitoring logic 112, driving environment assessment logic 113, analyzer logic 114, current lease logic 115, and new lease logic 116, where each logic module provides programming instructions for completing one or more tasks.

Still referring to FIG. 1, the operating logic 111 may include an operating system and/or other software for managing components of the electronic control unit 100. Further, the operating logic 111 may contain one or more software modules for monitoring data, transmitting data, and/or analyzing data. The behavior and vehicle conditions monitoring logic 112 may contain one or more software modules for monitoring data, transmitting data, analyzing data, collecting data and/or determining a behavior and vehicle conditions. The driving environment assessment logic 113 may contain one or more software modules for receiving data, monitoring data, transmitting data, and/or analyzing data to provide an assessment of the driving environment. The analyzer logic 114 may contain one or more software modules for receiving data, monitoring data, transmitting data, and/or analyzing data to provide analysis based on predetermined factors that are obtained by communication with the electronic control unit 100. The current lease logic 115 may contain one or more software modules for receiving data, monitoring data, transmitting data, and/or analyzing data to provide instructions to the software modules and components thereof. The new lease logic 116 may contain one or more software modules for receiving data, monitoring data, transmitting data, and/or analyzing data to provide a new lease recommendation based on predetermined factors that are obtained by communication with the electronic control unit 100.

Still referring to FIG. 1, sensors 120 can be communicatively coupled to the vehicle and onboard electronic control unit 100 communicatively coupled to the sensors 120. In embodiments a server device is communicatively coupled to the electronic control unit 100 including a memory component a database, and processors. The sensors 120 may include driver sensor 122 to detect behaviors of the driver, environment sensor 124 to detect environmental conditions, and/or vehicle sensor 126 to detect vehicle conditions.

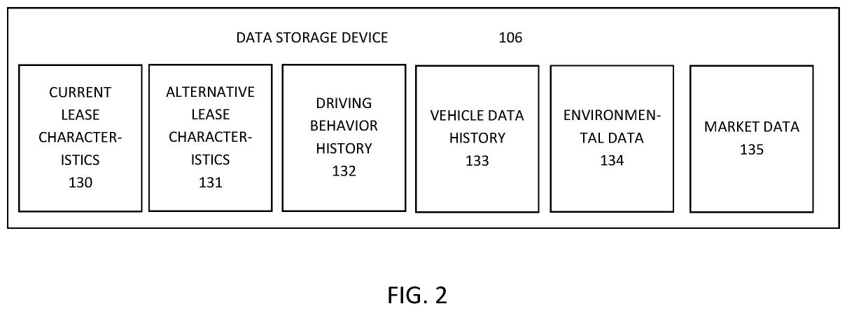

Referring to FIG. 2 the data storage device 106 of FIG. 1 which may generally be a storage medium, may contain one or more data repositories for storing data that is received and/or generated. The data storage device 106 may be any physical storage medium, including, but not limited to, a hard disk drive (HDD), memory, removable storage, and/or the like. While the data storage device 106 is depicted as a local device, it should be understood that the data storage device 106 may be a remote storage device, such as, for example, a server computing device or the like.

FIG. 2 schematically depicts a block diagram of various data contained within a storage device (e.g., the data storage device 106). As shown in FIG. 2, the data storage device 106 may include, for example, current lease characteristics 130, alternative lease characteristics 131, driving behavior history 132, vehicle data history 133, environmental data 134, and/or market data 135. It should be appreciated that while the data sensors 120 (FIG. 1) may record data to data storage device 106, the data may also be displayed live to a driver/user. As such, it should be appreciated that the data may not be stored permanently, but instead may be stored temporarily such that the data may be extracted therefrom.

FIG. 3 depicts a flow diagram 200, for generating a lease recommendation by providing a customizable plurality of options such as changes in current lease terms or creating new lease terms. The vehicle condition monitoring 210 generates vehicle operation data and generate vehicle environment data. The vehicle operations data characterizes one or more driving behaviors. Generally, a characteristic may be anything that can be detected and measured in the tangible world, sometimes with the use of sensory circuitry (e.g., sensors 120). It will be appreciated that various characteristics are contemplated herein and will become apparent to a person having ordinary skill in the art with the benefit of this disclosure.

Driving behavior characteristics may include information relating to braking, acceleration, speed, steering, lane changes, lateral movement, distance traveled, duration of travel, tailgating, and other characteristics. Information relating to braking, acceleration, steering, lateral movement, and other characteristics may be measured in units of force (or magnitude of force). In some examples, braking and acceleration information may be conflated into a single characteristic in which a negative value indicates braking and a positive value indicates acceleration. Information relating to speed and other characteristics may be measured in units of distance over time, such as miles per hour. Information relating to the distance traveled may be measured in units of distance, such as miles. Information relating to duration of travel may be measured in units of time, such as minutes, e.g., a measurement of the total number of minutes a driver has operated the vehicle, from the moment the engine started until it is shutdown (e.g., the engine ignition is switched off). Information relating to lane changes, tailgating, and other characteristics may be measured as Boolean values and/or numerical values. For example, information relating to a lane change may measure the riskiness of the lane change, taking into account the speed of the vehicle, the severity of the braking of the vehicle, and the severity of the steering of the vehicle. Information relating to tailgating may measure the proximity of the vehicle to another vehicle, taking into account the speed of the vehicle. In one example, a tailgate measurement may be a Boolean value, set to true if a predetermined threshold is exceeded with respect to a reasonable following distance while the vehicle is moving above a particular speed. Generally, many of the driving characteristics corresponding to driving behavior may be detected and measured with the use of a telematics or comparable device. In another example values for driving characteristics may be retrieved with the use of an accelerometer, gyroscope, proximity sensors, and/or digital compass in a device installed in or on the vehicle.

Vehicle condition characteristics may include, for example, engine temperature, tire pressure, environmental features, and other characteristics. Engine temperature may be measured in units of degree, such as Fahrenheit. Tire pressure may be measured in units of force per area, such as Pascal. Environmental features may be measured as a numerical value indicating the degree to which the operation is environmentally friendly (e.g., driving within particular speed ranges may be more conducive to maximum gas mileage and earn a higher environmental rating). Vehicle characteristics may relate to the run-time, dynamic condition of the vehicle and may be detected and measured with the use of sensory circuitry installed in the vehicle or in a vehicle telematics device, through an OBDII interface, or through an external server.

The driving environment assessment 220 generates vehicle environment data characterizing conditions (e.g., location characteristics, road rules characteristics, and the like) surrounding the vehicle during operation of the vehicle. Conditions may include, for example, location characteristics, time characteristics, weather characteristics, traffic characteristics, road rules characteristics, and other characteristics. Weather characteristics may include, for example, rain, snow, or hail information; visibility information (e.g., sunny, cloudy, foggy); wind speed, temperature, and other weather characteristics. The insurance underwriting module may query a third-party remote system via a network for information relating to such weather characteristics (e.g., a weather information server). Time characteristics may include, for example, the time of day, the day of the week, the day of the month, daylight, nighttime, or other time characteristic. Traffic characteristics may include, for example, traffic congestion, vehicle type, and other traffic characteristics. Road rules characteristics may include, for example, speed limit information, traffic signal information (e.g., stop signs, traffic lights), and other road rules characteristics. These characteristics may be measured or determined using sensors 120. Location characteristics may include, for example, geographic location (e.g., GPS coordinates), road surface information (e.g., parking lot, alley, highway, off-road, surface street), zip code, region (e.g., city, suburb, rural), or other location characteristics. Other examples of location characteristics may include characteristics relating to areas under construction, topography (e.g., flat, rolling hills, steep hills, curves), road type (e.g., residential, interstate, separated highway, city street, country road), road feature (e.g., intersection, gentle curve, blind curve, bridge, tunnel), intersections, roundabouts, railroad crossings, passing zones, merge point, the number of lanes, the width of the road or lanes, population density within a predetermined vicinity (e.g., within a radius, within a zip code), condition of the road (e.g., new, worn, severely damaged with sink-holes, severely damaged with erosion, gravel, dirt, paved), wildlife area, state, county, or municipality. The aforementioned characteristics may be measured/determined using sensors 120. The system may, for example, query one or more third-party remote systems via the network to obtain information relating to these or other location characteristics.

Factors from the driving behavior and vehicle condition monitoring 210 and driving environment assessment are considered within the driving behavior analyzer 230 to create leasing options 240. The driving behavior analyzer 230 may analyze the collected driving information and other information to determine a personalized leasing option for the driver. The driving behavior analyzer 230 may use machine learning or other techniques, such as artificial intelligence, statistical or predictive modeling, or other methods, to analyze the data. The driving behavior analyzer 230 may analyze some or all of the data associated with the driver to determine a predictive model that identifies a certain level of usage for the driver. The driving behavior analyzer 230 identifies driving behaviors that contribute to a different leasing options. These options may include to change lease terms 246 already existing or create lease terms 248 that are new.

FIG. 4 depicts a diagram various computing environments including driving behavior and vehicle condition monitoring 210, driving environment assessment 220, driving behavior analyzer 230, and lease actuator 340. As similarly described for FIG. 3, factors from the driving behavior 212 and vehicle conditions 214 are considered to obtain the driving behavior analysis 216.

As similarly described for FIG. 3, the driving environment assessment 220 generates vehicle environment data characterizing conditions (e.g., location characteristics, road rules characteristics, and the like) surrounding the vehicle during operation of the vehicle. Driving environment assessment 220 may include information from environment sensors 221 to measured and/or determine conditions. For example, environment sensors 221 may determine detection of roadway features 222, surrounding objects 223 and/or dynamic maps of the environment 235. The driving environment assessment 220 may also query one or more third-party remote systems via the network to obtain information relating to these or other location characteristics for real-time information 227. The driving environment assessment 220 uses the data obtained by environment sensors 221 to detect environment anomalies 226 that may affect usage of the vehicle.

As similarly described for FIG. 3, driving behavior analyzer 230 considers factors from vehicle condition monitoring 210 and driving environment assessment. The driving behavior analyzer 230 includes lease selector 332. As described above, the driving behavior analyzer 230 identifies driving behaviors that contribute to a different leasing options. Once a lease is selected, lease actuator 340 utilizes a lease actuation module 342 to implement the selected lease. The lease actuation module 342 uses driver behavior 212 and vehicle conditions 214 to implement a lease recommendation. At block 344 it is determined whether a current lease exists. If one does, the lease actuation module 342 is configured to modify 346 the lease. When the user has a current lease, the processor determines a plurality of changed lease terms corresponding to one or more needs of the user based on the analyzed driving behavior, the plurality of vehicle conditions, environment conditions, and the current market data for the specified vehicle. If a current lease does not exist, the lease actuation module 342 is configures to create 348 a lease. When the user does not have a current lease, the processor determines a plurality of new lease terms based on the analyzed driving behavior, the plurality of vehicle conditions, environment conditions, and the current market data for the specified vehicle.

In embodiments, the lease terms are displayed, such as by a computer, on a display within the vehicle. For example the lease may be displayed on a head unit display of the vehicle. A user may select lease options from user interface to cause the display. From the display, the user has the option of selecting new lease terms directly from the vehicle and having those lease terms implemented based on the selection.

In some embodiments, the analyzed driving behavior includes driving of the vehicle a significant amount such that the user will likely incur mileage overages, such as a predetermined amount of miles. The driving behavior can include parking the vehicle in a personal garage or carport as opposed to a street, public parking garage, or open lot. Attributes such as a driver score based on how carefully or aggressively the user operates the vehicle may be determined from the analyzed driving behavior and the plurality of vehicle conditions such that lease incentives may be provided to the user.

In some embodiments, the plurality of vehicle conditions include driven on-road as opposed to off-road or on poor road conditions and/or weather conditions.

In some embodiments, the lease terms further comprise a pay as you go option wherein the user pays on a monthly basis based on how many miles driven. The analysis and lease recommendation can include converting an allocation and accumulation of the allocated mileage of the current lease into points or currency enabling a user to make advanced payments on a new lease, apply points towards subscription credits for a vehicle service, and/or buy or receive a discount on accessories for their vehicle.

In some embodiments, generating lease incentives in response to good behaviors such as a user performing preventative and scheduled maintenance of the vehicle on time. Lease incentives may also be generated in response to good behaviors such as a user performing preventative and scheduled maintenance of the vehicle on time. The lease incentives are directed to providing an improved leasing experience while also integrating lessees into an ecosystem where they would be likely to continue to lease vehicles from the same dealer and/or manufacturer.

It will be understood by those of skill in the art that various alternatives of the above-described aspects and embodiments may be used without departing from the scope of the claims.

It should now be understood that embodiments described herein provide lease recommendations systems and methods thereof.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system comprising:
a vehicle;
a plurality of sensors communicatively coupled to the vehicle;
an onboard electronic control unit communicatively coupled to the plurality of sensors; and
a server device communicatively coupled to the electronic control unit, the server device comprising:
a memory component;
a database; and
one or more processors configured to:
generate vehicle operation data characterizing one or more driving behaviors or vehicle conditions detected during operation of the vehicle,
generate vehicle environment data characterizing a plurality of environment conditions surrounding the vehicle during operation of the vehicle,
generate a plurality of leasing options based on the one or more driving behaviors or vehicle conditions, the plurality of environment conditions, and a current market data for a specified vehicle, and
determine whether the user has a current lease,
wherein when the user has a current lease, the processor determines a plurality of changed lease terms corresponding to one or more needs of the user based on the analyzed driving behavior, the plurality of vehicle conditions, and the current market data for the specified vehicle, and
wherein when the user does not have a current lease, the processor determines a plurality of new lease terms based on the analyzed driving behavior, the plurality of vehicle conditions, and the current market data for the specified vehicle.

2. The system of claim 1 wherein the analyzed driving behavior includes driving of the vehicle a predetermined amount such that the user will likely incur mileage overages.

3. The system of claim 1 wherein the plurality of environment conditions comprises on-road driving and off-road driving.

4. The system of claim 1 wherein the plurality of environment conditions include weather conditions.

5. The system of claim 1 wherein the driving behavior includes parking the vehicle in a personal garage, in a carport, on a street, in a public parking garage, or in an open lot.

6. The system of claim 1 wherein the lease terms further comprise a pay as you go option wherein the user pays on a monthly basis based on how many miles driven.

7. The system of claim 1 wherein an allocation and accumulation of the allocated mileage of the current lease may be converted into points or currency enabling a user to make advanced payments on a new lease, apply points towards subscription credits for a vehicle service, and/or buy or receive a discount on accessories for their vehicle.

8. The system of claim 1 wherein attributes such as a driver score based on the user operates the vehicle may be determined from the analyzed driving behavior, the vehicle condition, and the plurality of environment conditions such that lease incentives may be provided to the user.

9. The system of claim 1 wherein lease incentives may also be generated in response to good behaviors such as a user performing preventative and scheduled maintenance of the vehicle on time.

10. The system of claim 1, wherein the one or more processors is further configured to display the lease terms in the vehicle and allow the user to make selections for the lease terms within the vehicle.

11. A method comprising:
generating vehicle operation data characterizing one or more driving behaviors or vehicle conditions detected during operation of the vehicle;
generating vehicle environment data characterizing a plurality of environment conditions surrounding the vehicle during operation of the vehicle;
generating a plurality of leasing options based on the one or more analyzed driving behaviors or vehicle conditions, the plurality of environment conditions, and a current market data for a specified vehicle; and
determining whether the user has a current lease;
and when the user has a current lease, determining a plurality of changed lease terms and propose a change in the lease terms corresponding to one or more needs of the user based on the analyzed driving behavior, the vehicle conditions, the plurality of environment conditions, and the current market data for the specified vehicle wherein,
and when the user does not have a current lease, determining a plurality of new lease terms based on the analyzed driving behavior, the plurality of vehicle conditions, and the current market data for the specified vehicle.

12. The method of claim 11 wherein the analyzed driving behavior includes driving of the vehicle a predetermined amount such that the user will likely incur mileage overages.

13. The method of claim 11 wherein the plurality of environment conditions comprises on-road driving and off-road driving.

14. The method of claim 11 wherein the plurality of environment conditions correspond to usage in weather conditions.

15. The method of claim 11 further comprising generating lease incentives in response to good behaviors such as a user performing preventative and scheduled maintenance of the vehicle on time.

16. The method of claim 11, further comprising displaying the lease terms in the vehicle and allowing the user to make selections for the lease terms within the vehicle.

17. A method comprising:
generating vehicle operation data characterizing one or more driving behaviors or vehicle conditions detected during operation of the vehicle;
generating vehicle environment data characterizing a plurality of environment conditions surrounding the vehicle during operation of the vehicle;
generating a driving score based on the driving behavior, vehicle conditions, and plurality of environment conditions;
generating a plurality of leasing options based on the driving score and a current market data for a specified vehicle, and
determining whether the user has a current lease,
and when the user has a current lease, determining a plurality of changed lease terms and proposing a change in the lease terms corresponding to one or more needs of the user based on the driving score and the current market data for the specified vehicle,
and when the user does not have a current lease, determining a plurality of new lease terms based on the driving score and the current market data for the specified vehicle.

18. The method of claim 17 wherein the analyzed driving behavior includes driving of the vehicle a predetermined amount such that the user will likely incur mileage overages.

19. The method of claim 17 wherein the plurality of environment conditions include driven on-road as opposed to off-road or on poor road conditions.

20. The method of claim 17, further comprising displaying the lease terms in the vehicle and allowing the user to make selections for the lease terms within the vehicle.
